(19) United States
(12) Patent Application Publication
(10) Pub. No.: US 2014/0280124 A1
(43) Pub. Date: Sep. 18, 2014

(54) Social Graph Sybils

(71) Applicants: Andrew Tikofsky, Oakland, CA (US); John Nicholas Gross, Berkeley, CA (US)

(72) Inventors: Andrew Tikofsky, Oakland, CA (US); John Nicholas Gross, Berkeley, CA (US)

(21) Appl. No.: 13/842,568

(22) Filed: Mar. 15, 2013

(51) Int. Cl. G06F 17/30

(52) U.S. Cl. CPC G06F 17/3053
USPC 707/735

(57) ABSTRACT

Artificial identities or information sources are created and used for—among other things—the purpose of manipulating the output of information retrieval, recommendation systems, or any information gathering and classifying technique based on relationships between information sources. Fictitious information sources or information designed to be recognized as untrustworthy by an information trust ranking system are created. By linking otherwise trustworthy information sources to fictitious information or information, they also appear less trustworthy. Target information or information sources are made to rank much lower in the output of systems designed to prioritize trustworthy information sources. Other applications include creating information or associations to make targeted information or information sources rank higher and reliable by information retrieval or recommendation systems.

### FIELD OF THE INVENTION

The present invention relates to creating, measuring and altering relationships in a social graph to control advertising, privacy and other related user interactions. The invention has particular applicability to Internet based social networking environments in which members are interconnected and have privacy/spamming concerns.

### BACKGROUND

Social networks can be characterized as a set of objects (nodes)—which are typically users—interconnected by some relationship (edges). To assess node and edge values, typical algorithms measure connectivity of everyone all at once by figuring out if a path starting at one point branches out enough to reach everyone else. In mathematical terms, the lowest eigenvalue for the matrix that connects everyone to everyone else is determined such that the sum of any one node's connections to the whole world is normalized to 1. Some connections with be assessed a zero connection to a given node while others have a high value because the user trusts or interacts a lot with another uses. The set of users' connectivity is measured by their value in this eigenvector. The higher the value, the more connected the user is in the social network. This technique allows a social network to find connected/trusted users and give them higher scores. Conversely if a user is connected to a small group of popular users, but a large group of unpopular users, this can reduce their social graph score.

### SUMMARY OF THE INVENTION

An object of the present invention is to create fictitious information or information sources in a connected network for the purpose of biasing the outcome of information retrieval systems.

A related object is to bias the outcome of recommendation systems.

A related object is to optimize the creation of information and information sources in order to look least trustworthy to information and information source evaluation methods and algorithms.

A related object is to optimize the relationship of this fictitious information to existing information sources in order to make them look less trustworthy.

A related object is to optimize the relationship of the fictitious information to existing information sources in order to make them look less trustworthy for certain types of information but not others.

A related object of the present invention is to allow multiple sources of information to rely on the same sources of fictitious information to bias the outcome of information retrieval systems.

A related object of the present invention is measure decay of the effectiveness of the fictitious information and sources of information and to define a mechanism for updating and maintaining them over time.

Another object of the present invention is to augment prior art by defining and storing a network of information sources based on a hierarchy of connections between these sources and to rank the connections based both on information type inputs and statistical measures.

A related object is to characterize ‘Trust Clusters’ in a network and to define relationships in a network based on these clusters.

A related object is to characterize node conductance in a network as well as secondary conductance as a node placement and network optimizing technique.

A related object is to characterize network separability and the associated classification algorithm.

Embodiments of the present invention exploit the nature of social graphs and their associated scoring algorithms to selectively control connectivity between users. In particular, fictitious users can be created and controllably connected to each other or a target user to make the latter have a lower score. In this manner a target user can be made less visible/trustworthy by association. In other instances connectivity between nodes can be controlled so at a first set of users have a high affinity to a particular node, while a second set of users have a low affinity for that node. This allows a target user to become more connected to users that they are most interested in.

It will be understood from the Detailed Description that the inventions can be implemented in a multitude of different embodiments. Furthermore, it will be readily appreciated by skilled artisans that such different embodiments will likely include only one or more of the aforementioned objects of the present inventions. Thus, the absence of one or more of such characteristics in any particular embodiment should not be construed as limiting the scope of the present inventions. Moreover while described in the context of an equities price prediction system, it will be apparent to those skilled in the art that the present teachings could be used in any number Internet based online communities.

### DESCRIPTION OF THE DRAWINGS

FIG. 1 is simplified block diagram of the main components and inputs/outputs used in preferred embodiment(s) of the invention;

FIGS. 2A and 2B are illustrations of diagram of the main components and inputs/outputs of a preferred embodiment of an information gathering engine and a network crawling engine respectively used in preferred embodiment(s) of the invention;

FIGS. 3A and 3B are illustrations of diagrams of the main components and inputs/outputs of a preferred embodiment of a social graph construction engine and a social network categorization engine respectively used in preferred embodiment(s) of the invention;

FIGS. 4A-4D are illustrations of diagrams of the main components and inputs/outputs of a preferred embodiment of a Sybil strategy generation engine, a Sybil placement mechanism, a Sybil detection strategy and Sybil placement strategy algorithms respectively used in preferred embodiment(s) of the invention;

FIGS. 5A and 5B are illustrations of diagrams of the main components and inputs/outputs of a preferred embodiment of a Sybil placement engine and a social node manufacturing engine respectively used in preferred embodiment(s) of the invention;

FIG. 6 is an illustration of the preferred processes and operations performed by preferred embodiment(s) of the invention.

### DETAILED DESCRIPTION

FIG. 1 is simplified block diagram of the main components and inputs/outputs used in preferred embodiment(s) of the invention. Except where noted, the main implementation of the Sybil features below is through one or more software routines, modules, etc., executing on a networked computer system. A “Sybil” as used herein refers to an artificial entity created for a host community that takes on the appearance of a human user, and can be in fact connected to real users or other Sybils. The existence of Sybils and their relationships to real users can be exploited to hide or least better conceal the identity, interests and other sensitive information of real users. For example real users may not wish to be targeted by advertisers because of their affinity for a particular food, consumer item brand, film/music interests, restaurant/vacation location preferences, etc., etc.

A set of User Lists and Goals 100 is first specified for the host entity attempting to protect its information from outside sources. A list of Sybil Strategies 215 is integrated with such list in order to define and build an overall multi-user Sybil strategy. The three main categories of distortion which the Sybils can implement include (see FIG. 6)

215a: Making existing Nodes/Links seem less trustworthy

215b: making Nodes harder to find in a search based on social networks and trust because they are ‘hidden in a cloud of Sybils;

215c: Sybils are used to create false or misleading relationships among nodes. Other examples will be apparent to those skilled in the art.

Returning to FIG. 1, 110 shows a User Node Characterization/Calculation Engine: The user's identity is defined and characterized by these routines by enumerating all of the links and information referring to the node or identity of interest;

120: Information Characterization Engine: All network information is defined by links and node information (any information content characterizing a node or user). The list of relevant details and operations is displayed in FIG. 2A, which shows:

120a: Link Information: All Link Information from 124 and 125 is preferably combined.

124: Link Classification Engine. Links are preferably classified into different types by these routines:
124a. Transactional Links: Those defining an interaction. They are based on activity of the user including commerce, exchange of information, posting on another's website, web-page, social network site, twitter account, etc.
124b. Behavioral Affiliations: behavior is typically defined by ‘liking’ something, choosing to belong to, have an affiliation with, or identify any involvement with. Examples would include favorite music, movies, school attendance, social organizations, etc. Other examples will be apparent to skilled artisan.
124c. Public Info Links: Any public information linking an identity with an activity or an organization. It can also include non-voluntary public information about an identity that can be used to classify them or associate them with any identifying characteristic.

125: is a set of routines making up a Link Hierarchy Ranking Engine:
125a. It will be understood that not all links and connections are equally important or reliable. Therefore different links categories define link importance. In addition, the link's importance is also ranked by the reliability attached to the link source node.

120a: Node Information: All Node Information from 122 and 123 is preferably combined.

122: Public Node Information
122a. Public Website Search Results
   122a1: Anything showing up in a general websearch
   122a2: Membership registration in organizations, associations, etc.
   122a3: Record of participation in activities associated with organizations, associations, etc.
122b. Social Networking Website information
122c. Mentioned in Public record, governmental or otherwise. An example might include contributions to political candidates or organizations.

123: Semi-Public Node Information
123a. Web behavior after login (cookies)
123b. Company specific internal information

As seen in FIG. 2B a network Crawler 130 is used to apply 120 (link and node characterization to the entire relevant network for the user. Thus user specific crawling rules 130a are used to define the relevant network for a specific user or node. The mechanism is standard but can include taking steps depending on the strength of the links between nodes in addition to the number of steps taken. Implicit is a ‘hierarchy’ of links and types of links that is referred to in 160 (FIG. 3A).

In FIG. 1 additional routines make up 140: Link/Node Categorization Engine: Once all of the link and node information has been gathered, it needs to be labeled and categorized by strength of connection, type of connection, categories of connectivity, etc. In this way, the entire existing host network is characterized as not just a set of links and nodes but also the type and strength of the nodes. There is an implicit feedback as link strength can depend partially on the trust assigned to the node from which it emanates.

150: Node and Link Information Storage: Conventional Industry-Standard data structures can be used for storing this information and achieve rapid retrieval. In addition data can be stored in multiple places for ease of retrieval and data integrity/redundancy (e.g. ‘the Data Cloud’).

160: Social Graph Construction Engine: Given all of the link and node information, interlocking graphs of connectivity are defined by these routines. This is done preferably in 2 ways as seen in FIG. 3A:

Method 1:

160a. Links are classified by defining characteristics or labels
160b. Networks are defined for each relevant separate link characteristic.
160c. Networks are stored for characteristics (labels) and sub-characteristics (sub-labels). For example, a user might be a baseball fan and then a sub-label would have them as an AAA league fan or a specific team fan.

Method 2:

160d. Given link connections and strengths associated with these connections, Social Networks are defined as clusters within the Social Graph.
160e. These statistical networks are defined and stored. They are characterized by size, strength of connections, inter-network conductivity.

Returning to FIG. 1, Social Network Characteristics 170 are stored using state of the art data storage and classification.

A social network categorization engine 180 has routines that categorize, sort and define the host social network. Again this is shown in more detail in FIG. 3B:
180a. Characterize ‘Trust Clusters’ and connectivity. Clustering is defined using standard Sybil detection techniques as described herein. In the present invention Sybil detection calculations are used to more optimally place Sybils with desired characteristics. Sybil detection techniques are described in (212).
175. Define a Trustworthiness of Node and input this into calculations.

180b. Connectivity and Conductance for each node, network, and sub-network. It is well known that node strength as well as their trust can be characterized by calculating their connectivity to the rest of the network using any number of conventional techniques. Determining weakly connected nodes can be used as a mechanism for Sybil determination. Therefore, individual node conductance is calculated and stored. Further, an additional calculation of a secondary conductance is performed, which is believed also to be unique to the present invention. This is a measure of the maximum conductance change of a node due to the placement of an additional link in the network.

180c. Network Interconnectedness or Overlap is quantitatively defined and characterized. Networks can naturally be interlinked networks and a measure of network overlap are defined and employed as well.

180d. The most important nodes (highest connectivity or conductance to the network) is defined for each Network.

180e. All relevant industry standard calculations for optimal Sybil placement are performed using any standard or evolving Sybil detection technique.

Returning to FIG. 1, Social Network Attack Calculations 190 are Stored for optimal retrieval and calculation.

200. Network Calculation Engine for Sybil Placement:

Many different features and data sets feed into this Engine. These are described in FIGS. 4A-4D and FIGS. 5A-5B. Initially, the strategy has to be defined in a precise quantitative way which is identified by routines 220.

220. User's Sybil Strategy Generation Engine.

In order to define a Sybil Strategy for a particular user in the host network, the following must be specified as seen in FIGS. 4A-4D.

214. Sybil Placement Strategies. These depend on the detection strategies (212) because, by construction, Sybils will be placed to interact with the detection strategies.

216. Sybil Placement Mechanisms. This is a function of the placement strategy (214) and the business strategy (215). The business strategies are defined in Sybil V.

220a. A Sybil need not be uniquely associated with a specific user or a specific node. It can be constructed to be associated with a number of users to the extent that it maintains desirable network properties.

220b. Sybil placement can be done to provide basic node hiding or shielding as well as other features (see 215). Since many of these features can be non-overlapping, they can be provided separately.

220c. Temporary versus Permanent Sybil Placement: The characteristics defining a Sybil can be placed in such a way that they are removable. For example, an identity in the social network need not be permanent or an interest or affiliation can be changed. The utility of this depends on the frequency of the Sybil Detection mechanism that is being implicitly targeted via Sybil placement.

In FIGS. 4A-4D a number of details relevant to Sybil placement and generation are listed under 212, 214, and 216. As described in these diagrams:

FIG. 4C shows routines 212 implementing Sybil Detection Strategies:

212a: SybilInfer, SybilGuard, SybilTrust. These are all variations of each other and rely on characterizing important nodal connections in the social network and defining Nodal conductivity. Sybils are characterized as those nodes with weak connectivity to the network.

212b: Eigentrust: This is one of a number of ways of defining Nodal importance in the entire network and relies on a single measure of conductivity and hence ranking within the network.

212c: Node Registration: Some Sybil detection strategies can rely on user registering themselves as trustworthy. Sybils can then be classified as non-members. If the host network is a partially closed system then it would be easy to have new identities excluded via Sybil classification.

212d: Node Rating System: nodes are rated based on trust or on connection to defined trustworthy nodes.

212e: Trust Groups or Networks are Used. One approach is based on labeling Trusted Nodes as defined in 175 (FIG. 3B) and defining a corresponding network. In general, a node is trusted based on the strength of its connection to this network.

FIG. 4D shows routines for implementing Sybil Placement Strategies 214. These strategies depend on the detection mechanism in 212.

214a: Cluster Degradation. Sybil nodes are preferably linked to a cluster in such a way that the cluster's internal conductivity decreases. More specifically, a specific node's connectivity to the cluster is preferably reduced. The node hierarchy calculated in 180 is used for this placement scheme.

214b: Cluster Building. Sybil nodes are preferably used to create associations and clusters thereby linking a node to a cluster. In (215), various strategies are discussed in which increased node linkage would be helpful for conveying information, misleading or otherwise. Categorization engine 180 is also relevant to this placement scheme.

214c: Conductivity Minimization or Maximization. Similar to cluster construction, Sybils can be placed to increase or decrease a node's conductivity within a cluster, to a set of clusters, or to the whole network.

214d: Monte Carlo Node Placement. Nodes can be placed deliberately using the calculations in 180 and 180b. Nodes can also be placed according to a statistical distribution given the information stored generated by engine 180. Because nodes interact with each other, the outcome of a specific distribution might vary so a set of statistically generated distributions are tested for optimal node and link placement.

214e: Node Hierarchy Identification. Nodes and links have a hierarchy on importance. If nodes are placed to link to more important points in the hierarchy, their effect is more pronounced.

214f: Node and Subnode Connectivity Rules. The Sybil placement strategy allows the possibility of placing nodes to have varying effects on distinct and overlapping subnetworks. The same Sybil can be linked to distinct subnetworks in differing ways with different intended affects.

As seen in FIG. 4B a set of routines implement Sybil Placement Mechanisms 216. Sybils can be placed in the network as nodes and the behavior that defines them as Sybils can be constructed in various ways:

216a: No responses to Queries or Requests. Sybils can intentionally ignore requests for links or acknowledgements. This behavior makes them look inherently inauthentic when doing so.

216b: Transaction Satisfaction (e.g. EBAY). Any system that gathers transaction evaluations is prone to manipulation and there are standard ways of recognizing manipulation and therefore, of looking like a manipulator.

216c: Registration of Nodes. Nodes have to be registered according to some Sybil placements systems. Choosing non-registration is easy or registering a small number of nodes and then connecting those ‘trusted nodes’ to a large number of Sybils potentially damaging any trust network.

216d: Ratings by Other Users. This is similar to 216b in that it is a rating or satisfaction of interaction system.

216e: Suspicious Connectivity Patterns. A class of Sybil detection looks for link and connectivity patterns thereby making ‘identifiable’ Sybil placement straightforward.

216f. Connection to untrustworthy nodes.

216g. Future Definitions

FIG. 1 shows a number of routines implementing a Network Calculation Engine 200 for Sybil Placement. The operation of these is shown in FIG. 5A in which an iterative method is preferably used for Sybil Placement calculation. Each potential placement is evaluated and improved upon as shown in 200a, 200b, and 200c.

Again with reference to FIG. 1 a routine 230 is used for Sybil Placement Calculation Storage. A Node Manufacturing Engine 240 is again implemented by one or more routines: This corresponds to actually creating Sybil identities and the links between them. A placement mechanism routine 216 drives this process.

Update Engine 205 is responsible for updating Sybil placement over time given a natural tendency for such entities to be erased or become less effective over time. The mechanism is described in FIG. 5B. The decision is driven by full network evaluation engine 250. However, a more abridged version is simply to evaluate the local changes rather than the entire network. This can be updated regularly with minimal calculation.

Referring to FIG. 5B therefore:

205a. Sybil Decay Evaluation. It is understood that this will happen for individual nodes and it is preferably monitored.

205b. Local Network Change Evaluation. It is expected that not only will the Sybil and its links decays but the effect of these links on the immediate area network will likely change over time.

205c. Update and Repair strategy is generated from 205a and 205b.

Returning to FIG. 1, an ongoing evaluation is performed by routines effectuating a network engine 250. This is the ongoing full network valuation. It involves a full network evaluation for the routines and operations described in connection with elements 120-200.

Update Strategy Engine 208. These routines implement an update network strategy generated from the evaluation by engine 250. It is understood that the network will be changed partially but not reconstructed from the beginning in this step.

The general motivation and strategy for Sybil placement is described in FIG. 6 as part of the main operations performed by the preferred embodiments:

215: Sybil Business Strategy List. A central preferred strategy is to contaminate the social graph/network with multiple new manufactured nodes (aka Sybils).

215a. Make existing nodes seem less trustworthy
215a-1. Make web information look suspect by identifying it with Sybils.
215a-2. Discredit accuracy of other user information by identifying it with Sybils
215a-3. Change user affiliation with existing networks by creating new and stronger affiliations.

215b: Nodes are made harder to find in a search based on social networks and trust because they are ‘hidden in a cloud of Sybils.

215b-1. Hide user information. A user is made to be perceived to be connected to untrustworthy users (Sybils) thereby making them look less trustworthy.

215b-2. Hide user from spam: Spam or advertising money is typically spent on users believed to be valuable as an advertising target. This is less likely to be true for users whose identity is tied with Sybils.

215b-3. Online games. Changes user characteristics by creating fake identities and interacting with them.

215b-4. Increase anonymity. A user associated with Sybils can be made harder to find in any search technique that screens for Sybils.

215c: Sybils are used to create false or misleading relationships among nodes.

215c-1. Standard approach. Sybils create false popularity, benefit ad campaign. A host network or other entity can change ratings or otherwise unattractive items by creating Sybils. However, this is only effective if the Sybils don't look fake to a screening mechanism.

215c-2. Smear/Advertising campaign. In some applications an entity may wish to make something look less trustworthy by associating it with fake information.

215c-3. Virally attack ads. To decrease effectiveness of a campaign, it can be discredited by associating it with Sybils.

215c-4. Contaminate and attack social network provider. Reduce functionality by creating Sybils that are effective in changing and degrading a rival social network.

215d. Determine and target relatively sparse parts of social network/web.

Embodiments of the present invention therefore can be used to protect information better than existing social networks, by augmenting and optimizing user graph profiles so that they are less accessible to unauthorized information retrieval entities. Examples of information that can be protected:

1) Private or Hidden Information: financial transactions, identity protected purchases, government/job records

2) Semi-Private Information: (Purchases on Amazon, web behavior after log-in, company internal non-shared info

3) Public Information: anything that shows up in websearch, Facebook, LinkedIn, twitter, people that mention a person or an entity, people mentioned by a person or an entity, record of activity, any website that shares public information

4) Derived Information and Relationships: the structure of the social graph, user links to people/entities/activities based on degrees of separation, interests in item/activity based on previous behavior, etc.

Embodiments of the invention affect derived information by making connections in the social graph seem less trustworthy. This is done for several reasons which benefit users:

a. makes targeting of users more difficult for undesired advertising campaigns;
b. Weakens non-voluntary networks to help users be more anonymous
c. Hides information for privacy, makes such information harder to find.
d. allows for less detection from peer to peer networks, change group affiliation (hate networks), and avoid spam
e. allows for less detection in online game networks

Other benefits and uses will be apparent to those skilled in the art. The present teachings are thus innovative in that the main focus is on decreasing connectivity in a social/interest graph, instead of increasing it, as opposed to search engine optimization techniques. The host network graph is thus parsed and defined so that an optimal set of Sybils and relationships can be gleaned.

To implement the above functions in FIGS. 1-6 it will be understood that a server computing system used by the described embodiments is preferably a collection of computing machines, databases, storage and accompanying software modules of any suitable form known in the art for performing the operations described above and others associated with typical website support. The software modules described above (referenced usually in the form of a functional engine) can be implemented using any one of many known programming languages suitable for creating applications that can run on client systems, and large scale computing systems, including servers connected to a network (such as the Internet). Such applications can be embodied in tangible, machine readable form for causing a computing system to execute appropriate operations in accordance with the present teachings. The details of the specific implementation of the present invention will vary depending on the programming language(s) used to embody the above principles, and are not essential to an understanding of the present invention.

The above descriptions are intended as merely illustrative embodiments of the proposed inventions. It is understood that the protection afforded the present invention also comprehends and extends to embodiments different from those above, but which fall within the scope of the present claims.

What is claimed is:

1. A method implemented on a computing system for changing the output of an information retrieval system that relies on the relationships between information sources or the trustworthiness of information sources in a social graph comprising:
a. defining target information or a target information source of interest;
b. defining a desired outcome for target requester information retrieval systems of interest attempting to access said target information or target information source;
c. defining, labeling, and storing relevant information and information sources for said desired outcome with the computing system;
d. providing a set of placement calculation algorithms adapted to generate misleading information to achieve said desired outcome to said target requester information retrieval systems;
e. generating and placing said misleading information within said social graph;
f. maintaining and updating said misleading information over time to meet and maintain said desired outcome.

2. The method of claim 1 wherein the desired outcome is to make a given information source (a Node) or its connection to other information sources (its links) appear to be less trustworthy by a system ranking the trustworthiness or reliability of said information.

3. The method of claim 2 wherein only a subset of information from an information source is reduced to have lower trustworthiness.

4. The method of claim 3 wherein a subnetwork is generated based on a subset, type, or other classification of information in the network and artificial information sources are only connected to this sub-network graph specifically to make the original information on the subnetwork graph appear to originate form an artificial source without affecting the perceived trustworthiness of other information from this source.

5. The method of claim 2 wherein information in contradiction to existing information is created for the purpose of making existing information less trustworthy.

6. The method of claim 1 wherein said information source is affected to have a reduced probability of showing up in search or information retrieval thereby making it appear substantially hidden.

7. The method of claim 5 wherein specific information such as an individual or corporate identity is hidden.

8. The method of claim 5 wherein a user is hidden from unwanted contact or connection such as spam mail or advertising.

9. The method of claim 5 wherein a portion of an entity's information is hidden.

10. The method of claim 5 wherein a user profile in an online game is perceived differently from a true profile.

11. The method of claim 1 wherein false information is used to create false popularity or to benefit an advertising campaign.

12. The method of claim 1 wherein false information is used to create false negative perception.

13. The method of claim 1 wherein false information is used to make an advertising campaign less effective.

14. The method of claim 1 wherein false information is implanted in a social network or social network provider for the purpose of reducing functionality.

15. The method of claim 1 wherein the false information is implanted in a system in order to bias recommendation systems.

16. The method of claim 15 wherein trust clusters and/or social clusters are targeted to bias recommendation system.

17. The method of claim 1 wherein multiple sources of information (nodes) rely on the same sources of fictitious information to separately bias results for these multiple nodes.

18. The method of claim 1 wherein an algorithm measures decay of the effectiveness of the fictitious information and sources of information over time.

19. The method of claim 1 wherein fictitious information sources are optimized in a network, by one more of the following operations:
a. Cluster Degradation in which fictitious nodes are linked to a cluster to decrease the cluster's internal conductivity, including to a targeted node;
b. Cluster Building in which fictitious nodes are used to create associations and clusters thereby increasing a node's linkage to a cluster;
c. Conductivity Minimization or Maximization in which fictitious nodes are placed to increase or decrease a node's conductivity within a cluster, to a set of clusters, or to the whole network;
d. Statistical Optimization of Nodal Placement, using node placement selection based on drawing random placement from a statistically defined placement distribution to create a locally optimal node;
e. Node Hierarchy Identification in which nodes are placed to link to influencers in the nodal hierarchy to achieve more pronounced effects;
f. Node and Subnode Connectivity Rules in which nodes are places to have a target effect on distinct and overlapping subnetworks.
